(19) United States
(12) Patent Application Publication
(10) Pub. No.: US 2011/0264775 A1
(43) Pub. Date: Oct. 27, 2011

(54) METHOD AND APPARATUS FOR SUPPORTING MIPV6 SERVICE IN A WIRELESS COMMUNICATION NETWORK

(75) Inventors: Dong-Hyun Lee, Gyeonggi-do (KR); Su-Lyeon Seong, Gyeonggi-do (KR)

(73) Assignee: POSCO ICT CO., LTD., Pohang (KR)

(21) Appl. No.: 12/672,501

(22) PCT Filed: Aug. 7, 2008
(86) PCT No.: PCT/KR2008/004592

§ 371 Date: Feb. 5, 2010

(30) Foreign Application Priority Data
Aug. 7, 2007 (KR) 10-2007-0079063

(51) Int. Cl. G06F 15/177

(52) U.S. Cl. 709/222

(57) ABSTRACT

A method and apparatus for supporting a Mobile Internet Protocol (MIP) service based on Proxy Mobile IP (PMIP) in a portable Internet network is provided. In the method for supporting a MIP service based on PMIP in a portable Internet network including multiple subnets, a Portable Subscriber Station (PSS) performs an initial network entry procedure to a first subnet, and then acquires an IPv6 address that it uses as a Home of Address (HoA). A first Access Control Router (ACR) in the first subnet, configures an IPv6 address of the first ACR as a first Care of Address (CoA) of the PSS, and performs a MIPv6 registration procedure with a Home Agent (HA) using the HoA of the PSS and the first CoA. As a result, the PSS, even though it undergoes handover, has no need to perform a CoA acquisition procedure or its MIPv6-related procedure in the new subnet, making it possible to receive a seamless service without delay and packet loss for the ongoing service.

### TECHNICAL FIELD

The present invention relates generally to a method and apparatus for supporting Mobile Internet Protocol version 6 (MIPv6) in a wireless communication network, and in particular, to a method and apparatus for supporting MIPv6 service based on Proxy Mobile IPv6 (PMIPv6) in a portable Internet network.

### BACKGROUND ART

The mobility support method available in the Mobile WiMAX standard is described as a Medium Access Control (MAC) protocol which is practiced between a Portable Subscriber Station (PSS) and a Radio Access Station (RAS) while the PSS moves between RASs. However, if the PSS moves to a new ACR/RAS of another subnet, it should accept a mobility support protocol of an IP layer in order to maintain the current ongoing session.

The MIPv6 technology established by MIPv6 Working Group of Internet Engineering Task Force (IETF) is the typical international standard protocol for the IP layer mobility support. In particular, if the advanced Mobile WiMAX service environment accepts the next generation Internet protocol of IPv6 in the future, MIPv6 will further increase in its importance as a mobility support protocol based thereon.

The above-stated MIPv6 technology binds, based on the dual-addressing system, a

Home of Address (HoA) of a PSS and a Care of Address (CoA) generated by a network to which the PSS has moved, and registers the result in a Home Agent (HA), thereby supporting the mobility. A description will now be made of handover as a typical example of the mobility support.

FIG. 1 is a diagram illustrating a configuration of a wireless communication network, particularly illustrating a configuration of a portable Internet network.

As illustrated in FIG. 1, the portable Internet network includes a Portable Subscriber Station (PSS) 100, Radio Access Stations (RASs) 200a and 200b for exchanging data with the PSS 100 over wireless interfaces, Access Control Routers (ACRs) 300a and 300b for controlling the PSS 100 and the RASs 200a and 200b, and routing IP packets, a Home Agent (HA) 400 supporting IP mobility of the PSS 100, and an Authentication, Authorization, Accounting (AAA) server (not shown) for performing authentication, authorization and accounting on the PSS 100 and its user. An IP network of each service provider, connected to the ACRs 300a and 300b, the HA 400 and the AAA server, is connected to the public IP network (Public Internet) to provide portable Internet service to the PSS 100.

FIG. 2 is a signaling diagram illustrating a method for providing MIPv6 service in a portable Internet network. For convenience' sake, it will be assumed herein that a first subnet and a second subnet exist. However, the number of subnets is extensible.

Referring to FIG. 2, steps S202 through S210 represent a procedure in which a PSS 100 equipped with a MIPv6 client sets up a session to a first subnet. Step S212 represents a procedure in which the PSS 100 moves from the first subnet to a second subnet, making a handover. Steps S214 through S222 represent a procedure in which the PSS 100 newly sets up a session to the new subnet, i.e., the second subnet. A detailed description thereof will be given below.

The PSS 100 is assigned a HoA from a HA 400 on the home network during its initial network entry. Once the PSS 100, assigned the HoA, enters the first subnet, the PSS 100 performs an IEEE 802.16e-based network entry procedure with an ACR 300a via a RAS 200a, and then acquires an IPv6 address that it will use as a CoA (Steps S202-S206). Further, the PSS 100 performs a Client MIPv6 (CMIPv6) registration procedure in the HA 400 using the CoA and HoA, and then makes communication with a Corresponding Node (CN) (Steps S208-S210).

Meanwhile, if the PSS 100 moves to the second subnet during its communication with the CN, it makes a handover between RASs 200a and 200b or between ACRs 300a and 300b of the first subnet and the second subnet (for example, inter-RAS handover in FIG. 2) (Step S212). Accordingly, the PSS 100 should perform an IPv6 address acquisition procedure in which it acquires a new IPv6 address from the ACR 300b in the second subnet. That is, the PSS 100 performs the IEEE 802.16e-based network entry procedure with the ACR 300b via the RAS 200b, and then acquires an IPv6 address that it will use as a new CoA (Steps S214-S218). Subsequently, the PSS 100 performs a CMIPv6 registration procedure in the HA 400 using the newly acquired CoA and the existing HoA, and then starts communication with the CN in the second subnet (Steps S220-S222).

As described above, the PSS 100 equipped with a MIPv6 client should detect the change in subnet every time handover occurs, acquire a new IPv6 address used as a CoA, and perform a procedure (Step S220) of making its registration in the HA 400 using the acquired CoA and the existing HoA, thereby causing a close of the session for the existing MIPv6 and suffering a data loss for a specific time (approximately 2 4 seconds) due to the above-stated procedures.

### DISCLOSURE OF INVENTION

### Technical Problem

Therefore, the present invention has been made in view of the above-mentioned problems, and it is an object of the present invention to provide a method and apparatus by which a service provider side provides a Proxy Mobile IPv6 (PMIPv6) client in a portable Internet network so as to make a PMIPv6-based MIPv6 service possible in the network.

It is further another object of the present invention to provide a method and apparatus by which a service provider side provides a PMIPv6 client in a portable Internet network so as to make a seamless traffic service possible during handover of a PSS.

It is another object of the present invention to provide a method and apparatus for supporting a MIPv6 function for a PSS when the PSS uses an IPv6 addressing system without the MIPv6 function in a portable Internet network.

### Technical Solution

According to one aspect of the present invention, there is provided a method for supporting a Mobile Internet Protocol version 6 (MIPv6) service in a wireless communication network including a plurality of subnets, the method comprising: (a) performing, by a Portable Subscriber Station (PSS), an initial network entry procedure to a first subnet, and then acquiring an IPv6 address which is used as a Home of Address (HoA); and (b) configuring, by a first Access Control Router (ACR) in the first subnet, an IPv6 address of the first ACR as a first Care of Address (CoA) of the PSS, and performing a MIPv6 registration procedure with a Home Agent (HA) using the HoA of the PSS and the first CoA.

It is desirable that the method further comprising: (c) when handover occurs for the

PSS from the first ACR in the first subnet to a second ACR in a second subnet, performing by the PSS a network entry procedure to the second subnet, and then configuring by the second ACR an IPv6 address of the second ACR as a second CoA of the PSS and performing a MIPv6 registration procedure with the HA using the HoA of the PSS and the second CoA.

According to another aspect of the present invention, there is provided a method for supporting a Mobile Internet Protocol version 6 (MIPv6) service by an Access Control Router (ACR) equipped with a Proxy Mobile IPv6 (PMIPv6) client in a wireless communication network, the method comprising: (a) determining if a Portable Subscriber Station (PSS) that has newly entered the network needs a new IPv6 address; (b) when it is determined that the PSS needs a new IPv6 address, including supportable IPv6 address acquisition information in a Router Advertisement (RA) message and sending the RA message to the PSS; and (c) performing a MIPv6 registration procedure with a Home Agent (HA) using an IPv6 address of the PSS and an IPv6 address of the ACR.

It is desirable that the method further comprising: (b′) when it is determined that the PSS has entered the network due to handover, performing a MIPv6 registration procedure with the HA using the IPv6 address of the ACR and an IPv6 address that the PSS acquired during its initial network entry.

According to further another aspect of the present invention, there is provided a method for supporting a Mobile Internet Protocol version 6 (MIPv6) service by a Portable Subscriber Station (PSS) in a wireless communication network including a plurality of subnets, the method comprising: (a) performing an IEEE 802.16e-based network entry procedure with a first Access Control Router (ACR) in a first subnet, the first ACR being equipped with a Proxy Mobile IPv6 (PMIPv6) client; (b) receiving from the first ACR a Router Advertisement (RA) message including IP address acquisition information therein; and (c) acquiring a new IP address according to the IP address acquisition information and sending the new IP address to the first ACR.

It is desirable that the method further comprising: (d) when handover occurs from a first Radio Access Station (RAS) in the first subnet to a second RAS in a second subnet, performing a network entry procedure to the second subnet with a second ACR in the second subnet, the second ACR being equipped with a PMIPv6 client.

According to still further another aspect of the present invention, there is provided an Access Control Router (ACR) for supporting a Mobile Internet Protocol version 6 (MIPv6) service in a wireless communication network, the ACR comprising: session processing means for performing a network entry procedure with a Portable Subscriber Station (PSS) that has newly entered the network; determination means for determining if the PSS needs a new IPv6 address; search means for searching for supportable IPv6 address acquisition information when it is determined that the PSS needs the new IPv6 address; message generation means for generating a Router Advertisement (RA) message including the searched IPv6 address acquisition information; reception means for receiving an IPv6 address that the PSS has newly acquired by using the IPv6 address acquisition information; and a Proxy Mobile IPv6 (PMIPv6) client for performing a MIPv6 registration procedure with a Home Agent (HA) using an IPv6 address of the PSS and an IPv6 address of the ACR.

According to still further another aspect of the present invention, there is provided an Access Control Router (ACR) for supporting a Mobile Internet Protocol version 6 (MIPv6) service in a wireless communication network, the ACR comprising: a control processor for performing a session processing function for handover and session setup/release to an IPv6 Portable Subscriber Station (PSS); and a data processor for performing data packet routing based on the processing result of the control processor; wherein the control processor comprises Proxy Mobile IPv6 (PMIPv6) client control means for performing an address registration procedure with a Home Agent (HA) by defining an IPv6 address of the ACR as a Care of Address (CoA) and defining as a Home of Address (HoA) an IPv6 address which is assigned to the IPv6 PSS in an IPv6 address acquisition procedure.

### ADVANTAGEOUS EFFECTS

The present invention equips the service provider side (e.g., ACR and gateway) with a PMIPv6 client, making it possible to provide a MIPv6 service even for a PSS having no MIPv6 function and also allowing the PSS to have no need to perform a CoA acquisition procedure or a MIPv6-related procedure. As a result, it is possible to provide the seamless service without packet loss.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram schematically illustrating a configuration of a portable Internet network;

FIG. 2 is a signaling diagram illustrating a method for providing MIPv6 service in a portable Internet network;

FIG. 3 is a block diagram illustrating a structure of an ACR according to an embodiment of the present invention;

FIG. 4 is a flowchart illustrating an operation of an ACR according to an embodiment of the present invention;

FIG. 5 is a diagram illustrating a procedure among an ACR equipped with a PMIPv6 client, a PSS and a HA according to an embodiment of the present invention;

FIG. 6 is a diagram illustrating protocol stacks for control planes of PSS, RAS, ACR, and HA according to an embodiment of the present invention;

FIG. 7 is a diagram illustrating protocol stacks for data planes of PSS, RAS, ACR, and HA according to an embodiment of the present invention; and

FIG. 8 is a signaling diagram illustrating a method for providing a PMIPv6-based MIPv6 service in a portable Internet network according to an embodiment of the present invention.

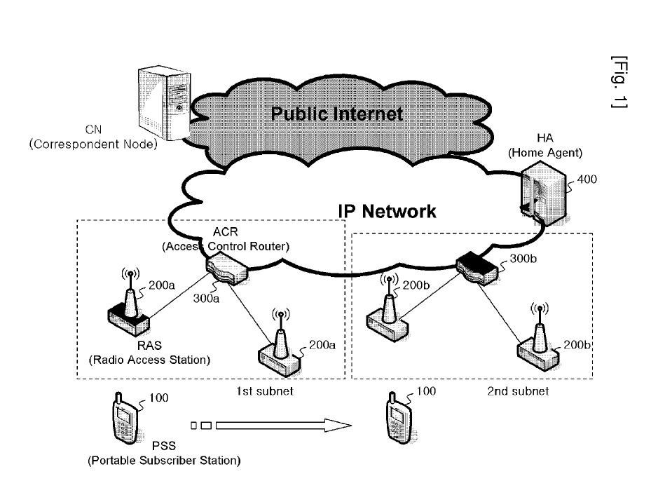

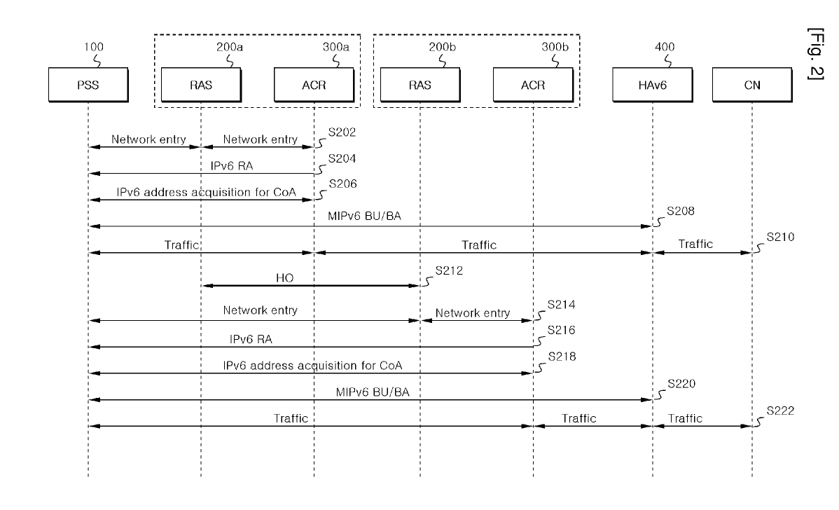

### MODE FOR THE INVENTION

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

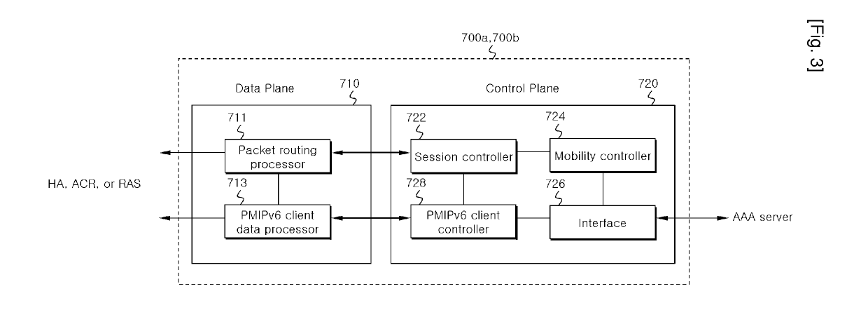

FIG. 3 is a block diagram illustrating a structure of an ACR according to an embodiment of the present invention.

As illustrated in FIG. 3, an ACR 700a (700b) includes a control plane 720 for performing control command processing, and a data plane 710 for performing packet routing. The control plane 720 and data plane 710 each can be realized in the form of an independent processor, and when necessary, can be realized in the form of a single processor.

The control plane 720 performs a session processing operation such as handover and session setup/release to an IPv6 address-based PSS, and delivers, to the data plane 710, routing information for each IP address of the PSS(s) which is added/changed/deleted according to the result of the session processing operation. To this end, the control plane 720 includes a session controller 722 for performing handover and setup/release of an IPv6 session, a mobility controller 724 for providing mobility of an IP address, an interface 726 for making a connection with an AAA server, and a PMIPv6 client controller 728 for performing a MIPv6 procedure (MIPv6 Binding Update (BU)/Binding Acknowledge (BA)) with a HA 400 using a Home of Address (HoA) and a Care of Address (CoA) of a PSS. In particular, the session controller 722 performs a network entry procedure with a newly entered PSS, and the mobility controller 724 determines if the PSS needs a new IP address. If it is determined that the PSS needs a new IP address, the mobility controller 724 searches for the currently supportable IP address acquisition information, and includes the searched IP address acquisition information in a Router Advertisement (RA) message to be transmitted to the PSS.

The data plane 710 changes a routing table of packets according to the changed routing information, and processes the corresponding packet according to the changed routing table. To this end, the data plane 710 includes a packet routing processor 711, and a PMIPv6 client data processor 713 that provides CoA to the PSS and serves as an end of an IPinIP tunnel.

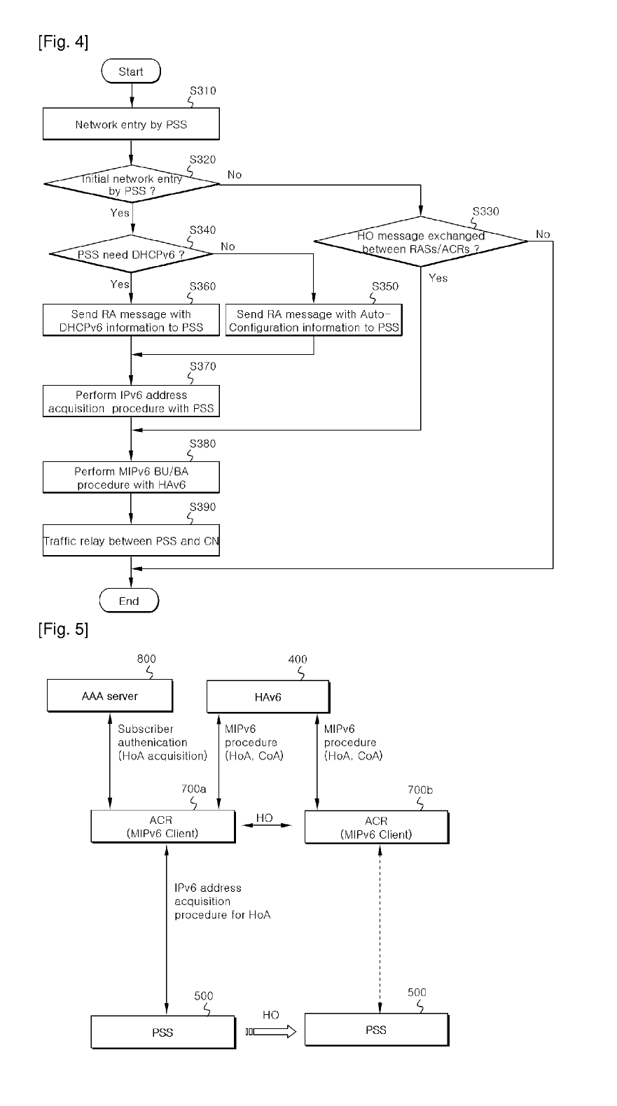

FIG. 4 is a flowchart illustrating an operation of an ACR according to an embodiment of the present invention, particularly illustrating an operation of an ACR equipped with a PMIPv6 client, and a PSS described below uses the IPv6 addressing system without supporting the MIPv6 function.

An ACR 700a (700b) performs an IEEE 802.16e-based network entry procedure with a PSS and approves corresponding PSS's access (Step S310). Subsequently, the ACR 700a (700b) determines if the PSS needs a new IPv6 address (Step S320). That is because the PSS needs a new IPv6 address for a HoA during its initial entry, but it uses a HoA acquired in the network that the corresponding PSS has initially entered during its entry caused by handover.

If it is determined in step S320 that a new IPv6 address is needed for the PSS, the ACR 700a (700b) searches for the currently supportable IP address acquisition method. That is, the ACR 700a (700b) determines if the PSS needs an IPv6 address acquisition procedure based on a Dynamic Host Configuration Protocol for IPv6 (DHCPv6) scheme (Step S340). If it is determined that there is the need, the ACR 700a (700b) generates a RA message having DHCPv6-based PSS IP address acquisition information and sends it to the PSS on a unicast basis (Step S360). However, if there is a need for an IPv6 address acquisition procedure based on a scheme other than the DHCPv6scheme, the ACR 700a (700b) generates a RA message having PSS IP address acquisition information based on an address Auto-Configuration scheme, and sends it to the PSS on a unicast basis (Step S350).

Accordingly, the PSS receives a RA message including therein the DHCPv6 information or address Auto-Configuration information, and acquires an IPv6 address according to the IPv6 address acquisition method included in the RA message (Step S370).

Thereafter, the ACR 700a (700b) performs a MIPv6 registration procedure with a HA 400 by defining as a HoA the IPv6 address that the PSS has acquired, and defining its IPv6 address as a CoA, and then relays communication between the PSS and a Corresponding Node (CN) (Steps S380-S390).

However, if it is determined in step S320 that the corresponding entry is an entry caused by handover, the ACR 700a (700b) performs a MIPv6 registration procedure with the HA 400 using the PSS's HoA and its IPv6 address (i.e., CoA), after omitting the new IP address acquisition procedure described in steps S340 through S370 (Step S380). Thereafter, the ACR 700a (700b) relays communication between the PSS and the CN (Step S390).

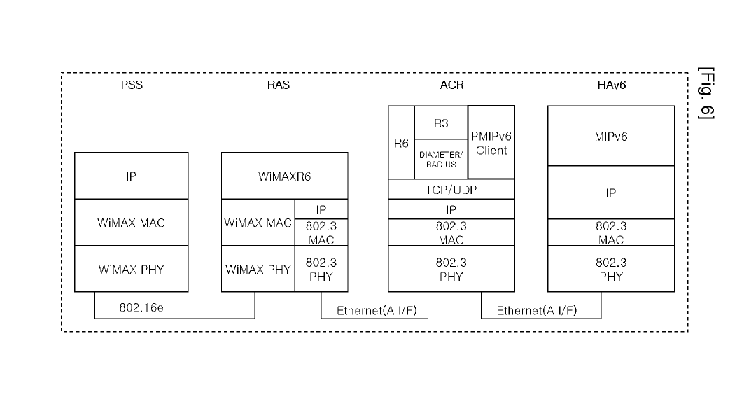

FIG. 5 is a diagram illustrating a change in a procedure among an ACR equipped with a PMIPv6 client, a PSS and a HA according to an embodiment of the present invention, particularly illustrating a MIPv6-related procedure for the case where the MIPv6 client is equipped in the ACR.

As illustrated in FIG. 5, a PSS 500 performs an IPv6 address acquisition (i.e., HoA acquisition) procedure with an ACR 700a, and a MIPv6-related procedure (for example, MIPv6 BU/BA) is performed between the ACR 700a (700b) and a HA 400. Accordingly, the PSS 500, even though it undergoes handover, has no need to perform the CoA acquisition procedure or MIPv6-related procedure, making it possible to receive the seamless service without delay and packet loss for the ongoing service.

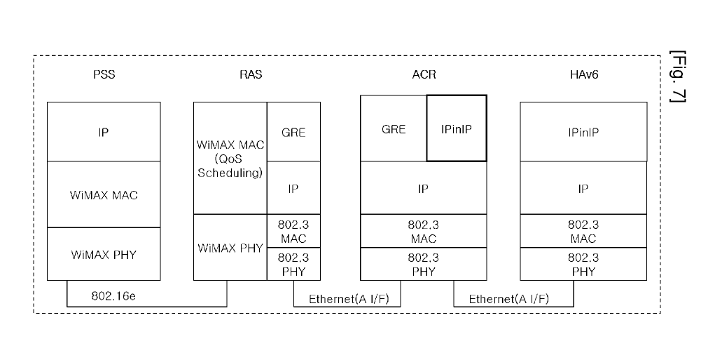

FIG. 6 is a diagram illustrating protocol stacks for control planes of PSS, RAS, ACR, and HA according to an embodiment of the present invention.

Referring to FIG. 6, for the control planes of the PSS, RAS, ACR and HA, the MIPv6-based protocol stack and PMIPv6-based protocol stack can deliver, in common, control information to a MIPv6 layer of the HA by equipping the ACR with a PMIPv6 client. In this case, in performing an address registration procedure in the HA, the PMIPv6 client uses as a HoA an IPv6 address assigned to the PSS by the IPv6 address acquisition procedure, and uses an IPv6 address of the ACR as a CoA.

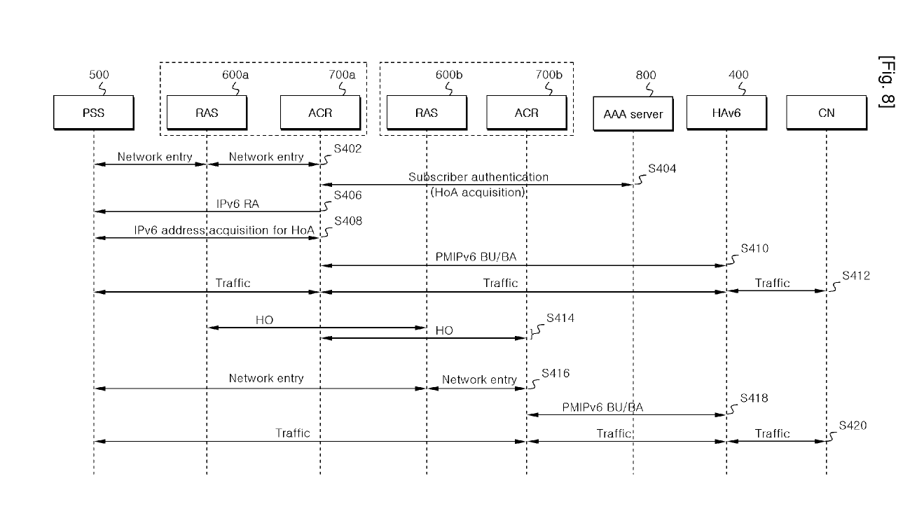

FIG. 7 is a diagram illustrating protocol stacks for data planes of PSS, RAS, ACR, and HA according to an embodiment of the present invention.

Referring to FIG. 7, for the data planes of the PSS, RAS, ACR and HA, the MIPv6-based protocol stack and PMIPv6-based protocol stack can process PMIPv6-based data in common by adding an IPinIP layer to the ACR, and can exchange data traffic by forming an IPinIP tunnel between the ACR and the HA.

FIG. 8 is a signaling diagram illustrating a method for providing a PMIPv6-based MIPv6 service in a portable Internet network according to an embodiment of the present invention.

Referring to FIG. 8, steps S402 through S412 represent a procedure in which a PSS 500 sets up an initial session to a first subnet. Step S414 represents a procedure for making a handover between RASs 600a and 600b or between ACRs 700a and 700b. Steps S416 through S418 represent a procedure in which the PSS 500 newly sets up a session to a new subnet, i.e., second subnet. A detailed description thereof will be given below.

The PSS 500 performs an IEEE 802.16e-based network entry procedure with an ACR 700a via a RAS 600a, and then acquires an IPv6 address that it will use as a HoA. That is, the PSS 500 accesses the ACR 700a through the IEEE 802.16e-based network entry procedure (Step S402). The ACR 700a performs subscriber authentication on the PSS 500 with an AAA server 800, and acquires a HoA of the PSS 500 from the AAA server 800 (Step S404). Accordingly, the ACR 700a determines if the PSS 500 needs a new IPv6 address, and only when there is the need, the ACR 700a searches for the currently supportable IP address acquisition method, generates an IPv6 RA message suitable for the scheme required by the PSS 500 according to the search result, and sends it to the corresponding PSS 500 on a unicast basis (Step S406). The PSS 500 receives the RA message, and performs an IPv6 address acquisition procedure according to an IPv6 address acquisition method included in the received RA message (Step S408). For example, the IPv6 address acquisition procedure can be classified into DHCPv6 and Auto-Configuration procedures.

Thereafter, the ACR 700a performs a MIPv6 registration procedure with a HA 400 by defining the acquired IPv6 address as a HoA and its IPv6 address as a CoA, and then initiates communication with a CN (Steps S410-S412).

If the PSS 500 moves to coverage of the second subnet during the communication, it makes a handover between RASs 600a and 600b and/or between ACRs 700a and 700b of the first subnet and second subnet (Step S414). Accordingly, the PSS 500 performs a new entry procedure to a RAS different from the RAS (not shown) in the first subnet, i.e., to the RAS 600b (ACR 700b) of the second subnet (Step S416).

An ACR 700b determines if the newly entered PSS 500 has initially entered (initial entry) or has entered due to handover (entry caused by handover). If the PSS 500 has entered due to handover as assumed herein, the ACR 700b registers a MIPv6 in the HA 400 using the HoA of the PSS 500 and its IPv6 address (i.e., CoA) after omitting the IP address acquisition procedure for the PSS 500, and then relays communication between the PSS 500 and the CN (Steps S418-S420).

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

1. A method for supporting a Mobile Internet Protocol version 6 (MIPv6) service in a wireless communication network including a plurality of subnets, the method comprising:
(a) performing, by a Portable Subscriber Station (PSS), an initial network entry procedure to a first subnet, and then acquiring an IPv6 address which is used as a Home of Address (HoA); and
(b) configuring, by a first Access Control Router (ACR) in the first subnet, an IPv6 address of the first ACR as a first Care of Address (CoA) of the PSS, and performing a MIPv6 registration procedure with a Home Agent (HA) using the HoA of the PSS and the first CoA.

2. The method of claim 1, further comprising:
(c) when handover occurs for the PSS from the first ACR in the first subnet to a second ACR in a second subnet, performing by the PSS a network entry procedure to the second subnet, and then configuring by the second ACR an IPv6 address of the second ACR as a second CoA of the PSS and performing a MIPv6 registration procedure with the HA using the HoA of the PSS and the second CoA.

3. The method of claim 2, wherein the MIPv6 registration procedure in the step (c) comprises:
generating by the second ACR a Proxy Binding Update (PBU) message using the HoA of the PSS and the second CoA, and sending the PBU message to the HA; and
sending by the HA a Proxy Binding Acknowledge (PBA) message to the second ACR in response to the PBU message.

4. The method of claim 1, wherein the IP address acquisition is performed by using address Auto-Configuration or Dynamic Host Configuration Protocol (DHCP).

5. The method of claim 1, wherein the network entry procedure to the first subnet and the network entry procedure to the second subnet follow an IEEE 802.16e-based network entry procedure.

6. The method of claim 1, wherein the step (a) comprises:
when the PSS completes the network entry procedure to the first subnet,
generating by the first ACR a Router Advertisement (RA) message based on an IPv6 address acquisition method supportable for the PSS and sending the RA message to the PSS.

7. The method of claim 1, wherein the MIPv6 registration procedure in the step (b) comprises:
generating by the first ACR a PBU message using the HoA of the PSS and the first CoA, and sending the PBU message to the HA; and
sending by the HA a PBA message to the first ACR in response to the PBU message.

8. A method for supporting a Mobile Internet Protocol version 6 (MIPv6) service by an Access Control Router (ACR) equipped with a Proxy Mobile IPv6 (PMIPv6) client in a wireless communication network, the method comprising:
(a) determining if a Portable Subscriber Station (PSS) that has newly entered the network needs a new IPv6 address;
(b) when it is determined that the PSS needs a new IPv6 address, including supportable IPv6 address acquisition information in a Router Advertisement (RA) message and sending the RA message to the PSS; and
(c) performing a MIPv6 registration procedure with a Home Agent (HA) using an IPv6 address of the PSS and an IPv6 address of the ACR.

9. The method of claim 8, further comprising:
(b′) when it is determined that the PSS has entered the network due to handover, performing a MIPv6 registration procedure with the HA using the IPv6 address of the ACR and an IPv6 address that the PSS acquired during its initial network entry.

10. The method of claim 8, wherein the IPv6 address acquisition information is acquired by using at least one of a Dynamic Host Configuration Protocol (DHCP) scheme and an address Auto-Configuration scheme.

11. The method of claim 10, wherein the MIPv6 registration procedure comprises:
generating a Proxy Binding Update (PBU) message using the IPv6 address of the PSS and the IPv6 address of the ACR, and sending the PBU message to the HA; and
receiving a Proxy Binding Acknowledge (PBA) message from the HA in response to the PBU message.

12. A method for supporting a Mobile Internet Protocol version 6 (MIPv6) service by a Portable Subscriber Station (PSS) in a wireless communication network including a plurality of subnets, the method comprising:
(a) performing an IEEE 802.16e-based network entry procedure with a first Access Control Router (ACR) in a first subnet, the first ACR being equipped with a Proxy Mobile IPv6 (PMIPv6) client;
(b) receiving from the first ACR a Router Advertisement (RA) message including IP address acquisition information therein; and
(c) acquiring a new IP address according to the IP address acquisition information and sending the new IP address to the first ACR.

13. The method of claim 12, further comprising:
(d) when handover occurs from a first Radio Access Station (RAS) in the first subnet to a second RAS in a second subnet, performing a network entry procedure to the second subnet with a second ACR in the second subnet, the second ACR being equipped with a PMIPv6 client.

14. The method of claim 12, wherein the IP address acquisition information is acquired by using at least one of a Dynamic Host Configuration Protocol (DHCP) scheme and an address Auto-Configuration scheme.

15. An Access Control Router (ACR) for supporting a Mobile Internet Protocol version 6 (MIPv6) service in a wireless communication network, the ACR comprising:
session processing means for performing a network entry procedure with a Portable Subscriber Station (PSS) that has newly entered the network;
determination means for determining if the PSS needs a new IPv6 address;
search means for searching for supportable IPv6 address acquisition information when it is determined that the PSS needs the new IPv6 address;
message generation means for generating a Router Advertisement (RA) message including the searched IPv6 address acquisition information;
reception means for receiving an IPv6 address that the PSS has newly acquired by using the IPv6 address acquisition information; and
a Proxy Mobile IPv6 (PMIPv6) client for performing a MIPv6 registration procedure with a Home Agent (HA) using an IPv6 address of the PSS and an IPv6 address of the ACR.

16. The ACR of claim 15, wherein when it is determined that the PSS has entered the network due to handover, the PMIPv6 client performs a MIPv6 registration procedure with the HA using an IPv6 address of the ACR and an IPv6 address that the PSS acquired during its initial network entry.

17. The ACR of claim 15, wherein the IPv6 address acquisition information is based on at least one of a Dynamic Host Configuration Protocol (DHCP) scheme and an address Auto-Configuration scheme.

18. An Access Control Router (ACR) for supporting a Mobile Internet Protocol version 6 (MIPv6) service in a wireless communication network, the ACR comprising:
a control processor for performing a session processing function for handover and session setup/release to an IPv6 Portable Subscriber Station (PSS); and
a data processor for performing data packet routing based on the processing result of the control processor;
wherein the control processor comprises Proxy Mobile IPv6 (PMIPv6) client control means for performing an address registration procedure with a Home Agent (HA) by defining an IPv6 address of the ACR as a Care of Address (CoA) and defining as a Home of Address (HoA) an IPv6 address which is assigned to the IPv6 PSS in an IPv6 address acquisition procedure.

19. The ACR of claim 18, wherein the data processor comprises PMIPv6 client data processing means that serves as an end of an IPinIP tunnel.
